(19) United States
(12) Patent Application Publication
(10) Pub. No.: US 2015/0186942 A1
(43) Pub. Date: Jul. 2, 2015

(54) SYSTEM AND METHOD FOR CROSS-PLATFORM MANAGEMENT OF ADVERTISEMENT SERVING

(71) Applicant: Sizmek Technologies Ltd., Herzliya (IL)

(72) Inventors: Jonathan Schler, Petach Tikwa (IL); Yoav ASSA, Tel Mond (IL); Ran ZIV, Rishon Lezion (IL); Anatoly KATZMAN, Modin (IL)

(73) Assignee: SIZMEK TECHNOLOGIES LTD., Herzliya (IL)

(21) Appl. No.: 14/587,429

(22) Filed: Dec. 31, 2014

Related U.S. Application Data
(60) Provisional application No. 61/922,356, filed on Dec. 31, 2013.

(51) Int. Cl. G06Q 30/02

(52) U.S. Cl. CPC G06Q 30/0257

(57) ABSTRACT

A computerized method and system for cross-platform management of advertisement serving are provided. The method includes receiving a request for a first advertisement from a first user device; serving the first advertisement to the first user device; receiving a request for a second advertisement from a second user device; serving the second advertisement to the second user device, wherein each of the first advertisement and the second advertisement comprises an advertisement area and an engagement area; determining, based on the first advertisement and the second advertisement, if the first user device and the second user device are used by a same user; and generating at least an entry in a registrar of a database to associate the first user device and the second user device with the same user.

### CROSS REFERENCE TO RELATED APPLICATIONS

This application claims the benefit of U.S. provisional application No. 61/922,356 filed on Dec. 31, 2013, the contents of which are herein incorporated by reference.

### TECHNICAL FIELD

The disclosure generally relates to the delivery of advertisements, and more specifically to the delivery of advertisements to a plurality of different user devices owned by a common user.

### BACKGROUND

Digital delivery of advertisements has become ubiquitous in the modern digital communication world. In some instances, the ability to display advertisements justifies the continued existence of a web site or service that otherwise would not have a sustainable business model. The delivery of an advertisement to a user device is a result of the user device attempting to access a web resource such as, e.g., a web page that is part of the display content sent to the user device. The web resource may also provide instructions regarding accessing an advertisement server that is configured to provide an advertisement responsive of the user device communication.

In certain cases, either the web server serving the information requested by the user device or the advertisement server also installs cookies on the user device that allow for the identification of the user device during a subsequent access. Such identification allows for more effective delivery of content and/or advertisements to the user device. For example, a user who has viewed an advertisement for a certain product should not view the exact same advertisement if an alternative advertisement for the same product can be served. This avoids overloading the user of the user device with the same advertisement multiple times.

Such a solution, however, is unable to address a common modern phenomenon wherein a single user may operate several user devices, typically possessing differing attributes. For example, the same user may operate a smartphone, a tablet, and a personal computer. The problem is that identification of one user device and installation of a cookie thereon does not identify the user when the user accesses a web resource via a different user device. For that matter, each user device operates independently of the other devices insofar as advertisements are concerned.

It is possible to have a user log on to an application using a user identification (UID) and, potentially, an accompanying password. However, a log in procedure is not usually practical in the context of serving advertisements. Hence, in the case of a user using a plurality of user devices, the prior art solutions are unable to avoid the resulting advertisement fatigue and/or attrition experienced as a result of repeated delivery of identical advertisements in any of the plurality of user devices used by the same user.

Therefore, in recognition of the deficiencies of the prior art, it would be advantageous to overcome the lack of a solution for identifying a user of a plurality of user devices and serving advertisements to the user that reflect the typical multi-platform environment of the modern user of web resources.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor to delineate the scope of any or all embodiments. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a computerized method and system for cross-platform management of advertisement serving. The method includes receiving a request for a first advertisement from a first user device; serving the first advertisement to the first user device; receiving a request for a second advertisement from a second user device; serving the second advertisement to the second user device, wherein each of the first advertisement and the second advertisement comprises an advertisement area and an engagement area; determining, based on the first advertisement and the second advertisement, if the first user device and the second user device are used by a same user; and generating at least an entry in a registrar of a database to associate the first user device and the second user device with the same user.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a network system for serving advertisement to a user of a plurality of user devices according to an embodiment;

FIG. 2 is a schematic diagram of an advertisement served to a user device according to an embodiment;

FIG. 3 is a flowchart illustrating serving advertisements in an environment where a user may operate a plurality of user devices according of an embodiment;

FIG. 4 is a flowchart illustrating serving an advertisement to an initially unknown user device according to an embodiment; and

FIG. 5 is a flowchart illustrating serving an advertisement to a known user device according to an embodiment.

### DETAILED DESCRIPTION

It is important to note that the embodiments disclosed herein are only examples of the many advantageous uses of the innovative techniques herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

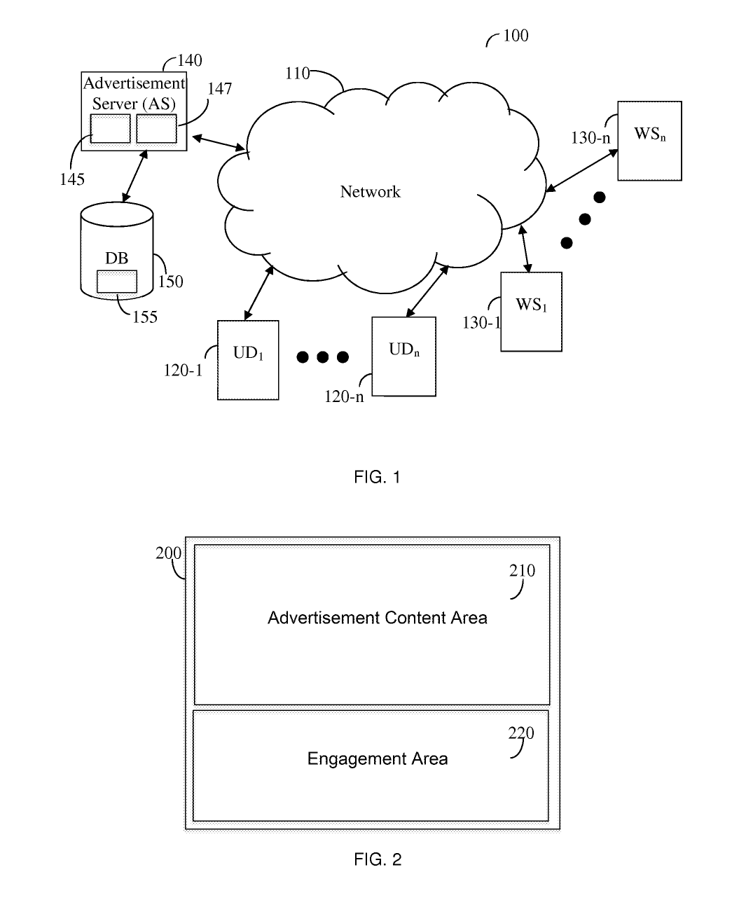

FIG. 1 depicts an exemplary and non-limiting schematic diagram of a network system 100 for serving advertisement to a user of a plurality of user devices 120 according to an embodiment. A network 110 that is communicatively connected to components of the system 100 may be an Internet protocol (IP) based network, which may include a local area network (LAN), a wide area network (WAN), a metro area network (MAN), a wide area network (WAN), the world wide web (WEB, also referred to occasionally as the Internet), as well as other kinds of networks that enable the delivery of web content and advertisements, and any combination thereof, including wired, wireless, and cellular networks.

User devices (UDs) 120-1 through 120-m are communicatively connected to the network 110, where ‘m’ is an integer having a value of ‘1’ or greater. A user (a person) may own or otherwise use multiple different user devices 120 on the network system 100. For illustration purposes only, and without limiting the scope of the disclosed embodiments, the user is assumed to use a user device UD₁ (120-1) and a user device UD₂ (120-2), where UD₁ (120-1) is a smartphone and user device UD₂ (120-2) is a personal computer (PC). One or more web servers (WSs) 130-1 through 130-n are further communicatively connected to the network 110, where ‘n’ is an integer having a value of ‘1’ or greater. A web server 130 is configured to provide to a user device 120 one or more web pages stored within the web server 130 responsive to a request from the user device to be provided with such one or more web pages.

A web page may contain one or more links that are used by the user device 120, upon execution for display of the web page received from a web server 130, to fetch advertisements. Typically, advertisements are served from an advertisement (ad)-serving system 140 that is communicatively connected to the network 110. It should be noted that, while a single ad-serving system 140 is shown, this is done merely for illustrative purposes and a plurality of ad-serving systems may be used, each accessed using a unique link, without departing from the scope of the disclosed embodiments. A link for an advertisement may be, but is not limited to, a universal resource locator (URL).

In an embodiment, the ad-serving system 140 is configured to accept user identifications provided via the user devices 120 and to identify common users among devices such that appropriate advertisements may be displayed to the user. Appropriate advertisements may include, but are not limited to, advertisements that the user has not previously viewed on any user device 120, a level of a game in an engagement area of an advertisement that the user has no played before, advertisements for products that the user has not been exposed to via the user device 120, and so on.

In another embodiment, the ad-serving system 140 is further configured to identify a common user between devices using explicit identifications and/or implicit identifications. Explicit identifications are typically provided by the user directly via, e.g., interaction with an engager of an engagement area of an advertisement (e.g., by playing a game). In embodiments where the explicit identification involves an engager, the user may be provided with an initial advertisement featuring the engagement. Upon identification of the user, a new advertisement may be presented in place of the initial advertisement.

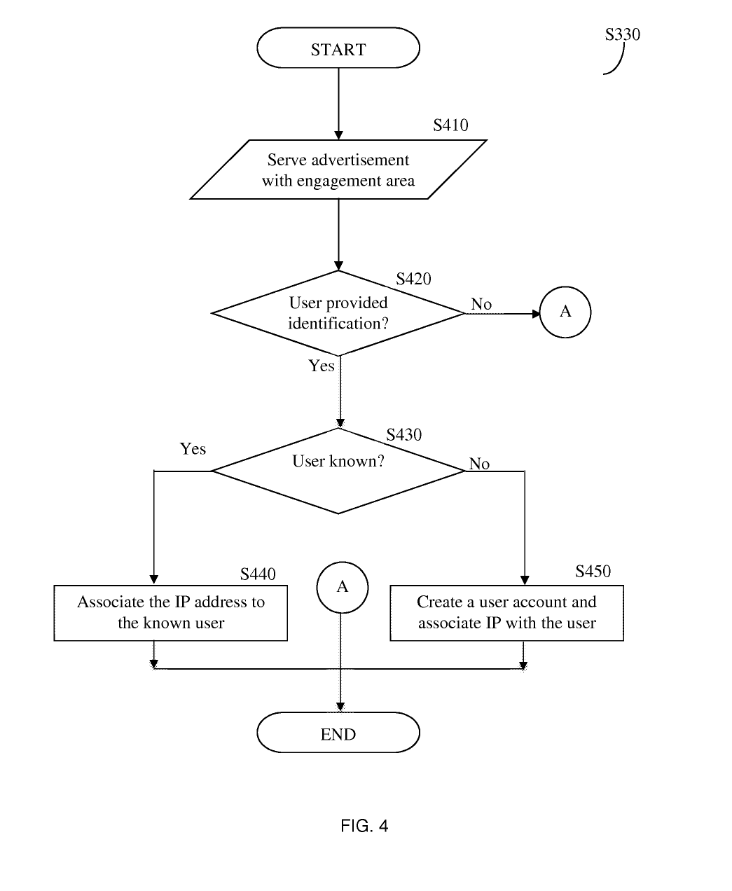

Implicit identifications are usually utilized when the user does not provide any explicit identification. An implicit identification is derived from analyzing various characteristics of the user devices to detect user devices that are accessible to or used by the same user. Such characteristics may include, but are not limited to, an IP address of the user device, a geographic location of the user device, LANs or wireless LANs that the devices are connected to, Bluetooth pairing between devices, applications installed on the user devices, and so on. Explicit identifications and implicit identifications are described further herein below with respect to FIG. 4.

The ad-serving system 140 may further include a memory 145 containing instructions that, when executed by a processing unit 147 of the ad-serving system 140, configure the ad-serving system 140 to provide an advertisement according to the embodiments disclosed herein. The processing unit 147 may comprise, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit 147 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing unit, cause the processing unit to perform the various functions described herein.

The ad-serving system 140 is further communicatively connected either directly (as shown) or indirectly (not shown) to a database 150 that includes a registrar 155 of users and their respective user devices 120. According to an embodiment, the registrar 155 is created by the ad-serving system 140 responsive of identification that a user device 120-2, for example UD₂, is operated by the same user as is UD₁ (user device 120-1). Using such an identification, it is possible to avoid overloading a user of a plurality of user devices 120 with multiple instances of the same advertisement or with otherwise uninteresting forms of advertisements (e.g., the same level of the same game included in an interactive advertisement). By configuring the ad-serving system 140 to identify different user devices 120 as belonging to the same user, more effective use of advertisement techniques is achieved and advertisement fatigue and attrition is avoided.

FIG. 2 describes an exemplary and non-limiting schematic diagram of an advertisement 200 delivered to a user device (e.g., the user device 120) according to an embodiment. The advertisement 200 prompts a user to provide a onetime unique identification by enticing the user to interact with the advertisement 200.

With this aim, according to one embodiment, the advertisement 200 is designed to include an advertisement content area 210 in which the advertisement content is provided and an engagement area 220 used to display an engager to the user of the user device. An engager is an interactive portion of an advertisement that may be used to, for example, pique the interest of a viewer of the advertisement, to entice the viewer to identify himself or herself via an explicit user identification (UID), and so on. The engager may be a game, a questionnaire, an opportunity to win a prize, a promise to win prizes, and so on, which entices the user to provide at least a unique UID. The UID may be, but is not limited to, a user name, a typical response of the user respective of an engager, a computer persona, a social media network account, an email address, a biological marker (e.g., a fingerprint, a retina scan, etc.), and so on. If the engager is a game, the game may be controlled by the user of the user device by, for example, touch screen controls, a keypad, a mouse, an accelerometer, a Global Positioning System (GPS) unit, and so on.

The engagement area 220 may additionally or alternatively display a menu. The menu may be or include one or more forms of entertainment, such as an interactive game. However, once the user has provided at least a UID, the details of the user device 120 that are identified pursuant to the interaction may be registered in the registrar 155, thereby associating a specific user device 120, for example UD₁ (120-1), with a particular user. Upon subsequent requests for advertisements from UD₁ (120-1), no additional identification will be required because, for example, data such as the Internet Protocol (IP) address of the user device may be known, a cookie may be used, and so on. As a result, the user of UD₁ (120-1) may be uniquely identified on each subsequent request for advertisements based on information stored in the registrar 155.

When the same user attempts to receive an advertisement from the ad-serving system 140 from a different user device 120, for example UD₂, the process of identification is repeated, thereby registering the user as associated with a second user device 120 in the registrar 155. This repetition allows a user to, for example, reach a certain level in a game played in the engagement area 220 on, for example, the user device UD₁ (120-1), and to continue from that level on, for example, the user device UD₂ (120-2), in a seamless manner, and as further explained herein. Alternatively or additionally, this repetition may allow an advertiser to provide a different advertisement to a user each time the user accesses the website from a different user device. It should be noted that using the advertisement's 200 format would yield higher user engagement with the advertised content, as the user would be incentivized to view and interact with the advertisement 200.

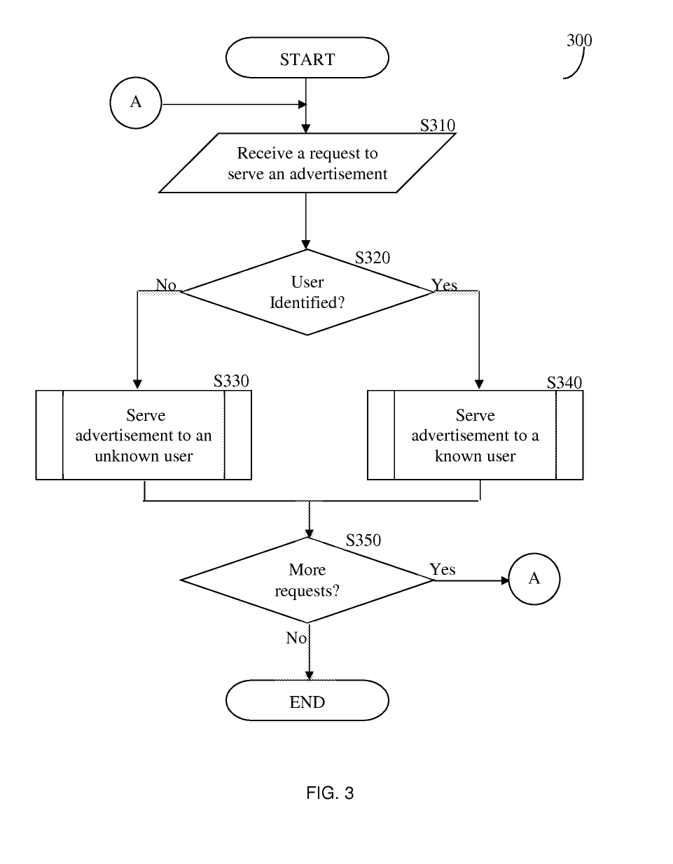

FIG. 3 shows an exemplary and non-limiting flowchart 300 illustrating a method for serving advertisements in an environment where a user may operate a plurality of user devices according of one embodiment. In S310, a request for serving an advertisement is received. In an embodiment, the request may be received at the ad-serving system 140 from a user device 120 such as, for example, user device 120-1. In that embodiment, the request may include identification information respective of the user device 120-1, and may include, but is not limited to, the IP address of user device 120-1, a unique UID provided by a cookie installed on the user device 120-1, and so on.

In S320, it is checked whether a user of, for example, user device 120-1 has been identified in the registrar 155. If not, execution continues with S330; otherwise, execution continues with S340. In S330, an advertisement is served to an initially unknown user before execution continues with S350. Serving advertisements to an initially unknown user device is described further herein below with respect to FIG. 4.

In S340, the advertisement is served to an identified user. Serving advertisements to identified users is described further herein below. In S350, it is checked whether additional requests are to be served by ad-serving system 140 and, if so, execution continues with S310; otherwise, execution terminates.

FIG. 4 depicts an exemplary and non-limiting flowchart S330 illustrating a process for serving an advertisement to an initially unknown user device according to an embodiment. In S410, an advertisement is provided to the requesting initially unknown user device. In an embodiment, the advertisement may be formatted similarly to the advertisement described further herein above with respect to FIG. 2. In an embodiment, the user of the initially unknown user device views the advertisement in an advertisement content portion (e.g., the advertisement content area 210) and engages an engagement portion (e.g., the engagement area 220).

In S420, it is checked whether the user has provided user identification and, if so, execution continues with S430; otherwise, execution terminates. User identifications that are provided may include, but are not limited to, explicit identifications. Explicit identifications are typically provided by the user directly via, e.g., interaction with an engager of an engagement area of an advertisement (e.g., by playing a game), and so on.

As a non-limiting example of providing user identifications, a user initially views a first advertisement of a website on a user device ‘UD₁ and creates a UID associated with the user by interacting with an engager in an engagement area of the advertisement. When the user subsequently accesses a second advertisement that is hosted by the website on a second user device UD₂, he or she may be presented with an opportunity to interact with an engager in an engagement area of the advertisement. If the user's interaction with the engager of the second advertisement is similar to his interaction with the engager of the first advertisement, it may be determined that the user of the UD₂ is the same as the user of UD₁

In S430, it is checked whether the information collected belongs to a registered user and, if so, execution continues with S440; otherwise, execution continues with S450. In an embodiment, user registrations may be stored in a registrar (e.g., the registrar 155).

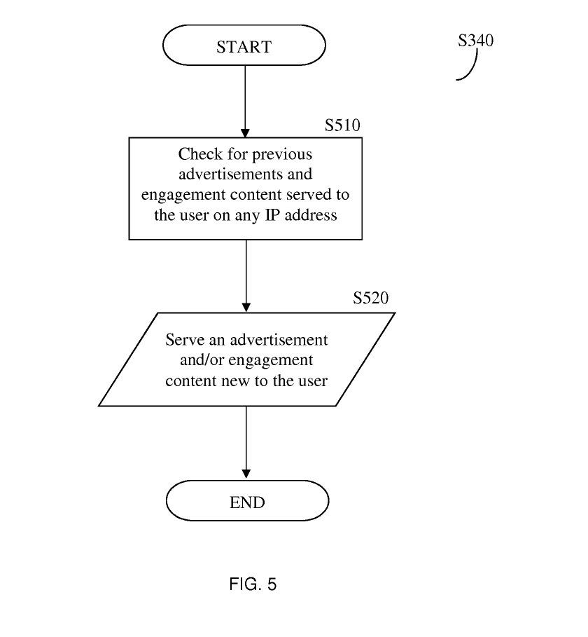

In S440, the identification of the initially unknown user device (e.g., the user device 120-1) is associated with an existing user entry of the registrar, thereby resulting in an additional user device (e.g., the user device 120-1) being associated with the same user as that of the user entry. Thereafter, as demonstrated herein below with respect to FIG. 5, regardless of which of the user devices (e.g., the user devices 120) that the user accesses advertisements with, an appropriate (i.e., non-repetitive) advertisement can be served to the user.

In S450, a new user entry is created for the user of the user device (e.g., the user device 120-1) as the user was not identified as a previously registered user. According to one embodiment, even though a user device (e.g., the user device 120-1) is registered, the identification information may be entered by the user to effectuate changes in ownership, errors made when entering information, and so on. Such entered identification information may be received upon, e.g., a request by the user.

According to one embodiment, if user does not provide an explicit identification, the association of user devices to users can be performed based on implicit identifications. As noted above, an implicit identification is derived from analyzing various characteristics of the user devices, but are not limited to, an IP address of the user device, a geographic location of the user device, LANs or wireless LANs that the devices are connected to, Bluetooth pairing between devices, applications installed on the devices, operating profiles, and so on.

As an example, an indication that the UD₁ and UD₂ are connected to the “Work” network during the day and “Home” network during the evenings may provide an indication that the two user devices belong to the same user. Such indications may be correlated with cookies stored in the UD₁ and UD₂ when serving advertisements to these devices. It should be further noted that association of devices with users by means of the implicit identifications is also stored in the registrar 155.

FIG. 5 is an exemplary and non-limiting flowchart S340 illustrating a process for serving an advertisement to a known user device according to an embodiment. In S510, both the content area (e.g., the content area 210) and the engagement area (e.g., the engagement area 220) of any previous advertisements (such as, e.g., the advertisement 200) in an attempt to prevent repetition of either or both areas when the advertisement is served to the user of the known user device making the request. This is performed based on information stored in a database (e.g., the database 150) as well as in a registrar (e.g., the registrar 155).

In S520, a created advertisement (e.g., the created advertisement 200) containing advertisement content in a content area (e.g., the content area 210) and an engager in an engagement area (e.g., the engagement area 220) are provided to the requesting known user device. The engager may be a game, a questionnaire, a promise to win prizes, and so on, which entices the user to provide at least a unique UID.

Following is a non-limiting example: a user has two user devices 120-1 and 120-2. The user connects to a web server, for example, web server 130-1, to receive a web page via user device 120-1. The web page contains a link that directs user device 120-1 to receive advertising content from the ad-serving system 140. In this example, the ad-serving system 140 provides an advertisement 200 containing an advertisement for a beverage depicting the beverage consumed in a basketball game setting in the advertisement area 210. The advertisement further provides an engager in the engagement area 220. As a result of an interaction by the user of UD₁, the UD₁ is registered in the registrar 155 of database 150 as belonging to a user providing the unique UID provided by the user.

If the engager was a game featuring multiple levels, the user may reach the second level of the game on UD₁. Subsequently, when the same user attempts access to a web server such as, for example, server 130-m, using a different user device, for example user device 120-2, the user also receives a link from the provided web page to access the ad-serving system 140. As a result, the provided advertisement attempts to engage the user, now using user device 120-2 and entices the user to provide a unique UID which is now identified as existing in the registrar 155. As a result, the engager may be the same game provided when the user was using a user device 120-1, but now the game may begin at a higher level, for example level three, as the user was identified to have passed the first two levels. If the user fails to provide explicit identification during subsequent use, an implicit identification provided by UD₁ may be used to attempt to determine whether the user of UD₂ is the same as an existing user. For example, if the user devices UD₁ and UD₂ are currently connected to the same wireless network or previously connected to the same wireless network, it may be determined that UD₁ and UD₂ are used by the same user.

It should be noted that the above example is not intended to be an extensive description of all the aspects of the embodiments disclosed herein, rather, it provides a particular embodiment.

The various embodiments disclosed herein can be implemented as hardware, firmware, software or any combination thereof. Moreover, the software is preferably implemented as an application program tangibly embodied on a program storage unit, a non-transitory computer readable medium, or a non-transitory machine-readable storage medium that can be in a form of a digital circuit, an analog circuit, a magnetic medium, or combination thereof. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

While the disclosed embodiments been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A computerized method for cross-platform management of advertisement serving, comprising:
receiving a request for a first advertisement from a first user device;
serving the first advertisement to the first user device;
receiving a request for a second advertisement from a second user device;
serving the second advertisement to the second user device, wherein each of the first advertisement and the second advertisement comprises an advertisement area and an engagement area;
determining, based on the first advertisement and the second advertisement, if the first user device and the second user device are used by a same user; and
generating at least an entry in a registrar of a database to associate the first user device and the second user device with the same user.

2. The computerized method of claim 1, wherein the first advertisement is not identical to the second advertisement.

3. The computerized method of claim 1, wherein determining if the first user device and the second user device are used by the same user is based on at least one of: an explicit identification, and an implicit identification.

4. The computerized method of claim 3, wherein the explicit identification is an interaction with an initial engager in the first advertisement.

5. The computerized method of claim 3, wherein the implicit identification is any of: an internet protocol (IP) address of the user device, a geographic location of the user device, a local area network (LAN) that the first user device and the second user device are connected to, a wireless LAN that the first user device and the second user device are connected to, a Bluetooth pairing between the first user device and the second user device, and an application installed on the first user device and the second user device.

6. The computerized method of claim 3, further comprising:
determining if the user has provided an explicit identification; and
upon determining that the user has not provided an explicit identification, analyzing an implicit identification of the user.

7. The computerized method of claim 1, wherein the engagement area comprises an engager.

8. The computerized method of claim 7, wherein the engager is configured to collect identifying information from the user.

9. The computerized method of claim 7, wherein the engager is at least one of: a game, a questionnaire, an opportunity to win a prize, and a promise to earn a prize.

10. The computerized method of claim 8, wherein generating the at least an entry in the registrar of the database further comprising:
determining, based on a user identification, whether the user is previously registered;
upon determining that the user is not previously registered, creating a new user entry in the registrar of the database respective of the user; and
storing the collected identifying information in the registrar.

11. The computerized method of claim 1, wherein the content of the second advertisement is based at least on content previously provided to at least of one of: the first user device, and the second user device.

12. A non-transitory computer readable medium having stored thereon instructions for causing one or more processing units to execute the method according to claim 1.

13. A system for delivering an advertisement to a user device of a user who may access a plurality of user devices, comprising:
an advertising server;
a processor; and
a memory, the memory containing instructions that, when executed by the processor, configure the system to:
receive, by the advertising server, a request for a first advertisement from a first user device;
serve the first advertisement to the first user device;
receive a request for a second advertisement from a second user device;
serve the second advertisement to the second user device, wherein each of the first advertisement and the second advertisement comprises an advertisement area and an engagement area;
determine, based on the first advertisement and the second advertisement, if the first user device and the second user device are used by a same user; and
generate at least an entry in a registrar of a database to associate the first user device and the second user device with the same user

14. The system of claim 13, wherein the first advertisement is not identical to the second advertisement.

15. The system of claim 13, wherein determining if the first user device and the second user device are used by the same user is based on at least one of: an explicit identification, and an implicit identification.

16. The system of claim 15, wherein the explicit identification is an interaction with an initial engager in an initial advertisement.

17. The system of claim 15, wherein the implicit identification is any of: an internet protocol (IP) address of the user device, a geographic location of the user device, a local area network (LAN) that the first user device and the second user device are connected to, a wireless LAN that the first user device and the second user device are connected to, a Bluetooth pairing between the first user device and the second user device, and an application installed on the first user device and the second user device.

18. The system of claim 15, wherein the system is further configured to:
determine if the user has provided an explicit identification; and
upon determining that the user has not provided an explicit identification, analyze an implicit identification of the user.

19. The system of claim 18, wherein the engagement area comprises an engager.

20. The system of claim 19, wherein the engager is configured to collect identifying information from the user.

21. The system of claim 19, wherein the engager is at least one of: a game, a questionnaire, an opportunity to win a prize, and a promise to earn a prize.

22. The system of claim 20, wherein the system is further configured to:
determine, based on a user identification, whether the user is previously registered;
upon determining that the user is not previously registered, create a new user entry in the registrar of the database respective of the user; and
save the collected identifying information in the registrar.

23. The system of claim 13, wherein the content of the second advertisement is based at least on content previously provided to any one of: the first user device, and the second user device.
